(19) United States
(12) Patent Application Publication
(10) Pub. No.: US 2015/0268647 A1
(43) Pub. Date: Sep. 24, 2015

(54) USER BASED HOME AUTOMATION METHOD, APPARATUS THEREOF, AND SUPPORTING METHOD AND APPARATUS THEREFOR

(71) Applicant: Electronics and Telecommunications Research Institute, Daejeon (KR)

(72) Inventors: Eun-Jin KO, Daejeon (KR); Ji-Yeon KIM, Daejeon (KR); Jong-Hyun JANG, Daejeon (KR); Deock-Gu JEE, Daejeon (KR)

(21) Appl. No.: 14/640,574

(22) Filed: Mar. 6, 2015

(30) Foreign Application Priority Data
Mar. 20, 2014 (KR) 10-2014-0032840

(51) Int. Cl. G05B 15/02; H04L 12/28; G06F 17/30

(52) U.S. Cl. CPC G05B 15/02; G06F 17/3053; H04L 12/2816

(57) ABSTRACT

The present invention relates to a home automation method and apparatus and a method and apparatus for supporting the same. The home automation method from a home device according to an embodiment of the present invention comprises selecting a service scenario comprising at least one unit function, the service scenario being selected by a user; requesting to provide a unit function list applicable to the selected service scenario to a server when there is a request to modify a unit function for the selected service scenario from the user; and applying at least one unit function, selected by the user from the unit function list received from the server, to the selected service scenario and storing the result. According to embodiments of the present invention, customized services which fit to a user can be provided.

### CROSS-REFERENCE TO RELATED APPLICATION

This application claims priority to and the benefit of Korean Patent Application No. 2014-0032840, filed on Mar. 20, 2014, the disclosure of which is incorporated herein by reference in its entirety.

### BACKGROUND

1. Field of the Invention

The present invention relates to a user-based home automation method and apparatus and a method and apparatus for supporting the same.

2. Discussion of Related Art

Home automation technology has been developing with growth in information collection technologies through sensors and device control-related technologies.

Home automation technologies determine home situation based on information collected through sensors which are installed in a house and provide services according to the service scenario corresponding to the currently determined home situation among predetermined service scenarios. For example, home automation informs the current home situation to a user or automatically controls a device installed in a house according to the service scenario rules.

A method of informing current situation to a user may cause a problem of not handling properly when the user has not received the current situation or when the user has checked late.

Controlling devices in a house automatically also has drawbacks of not providing services which are considered with unique characteristics of the user or the house.

### SUMMARY OF THE INVENTION

Exemplary embodiments of the present invention are to provide services which are considered with unique characteristics of the user or the house.

A home automation method from a home device according to an embodiment of the present invention comprises selecting a service scenario comprising at least one unit function, the service scenario being selected from a user; requesting to provide a unit function list applicable to the selected service scenario to a server when there is a request to modify a unit function for the selected service scenario from the user; and applying at least one unit function, selected by the user from the unit function list received from the server, to the selected service scenario and storing the result.

A home device performing home automation according to an embodiment of the present invention comprises a communication part, a storing part; and a controlling part receiving a selection of a service scenario comprising at least one unit function from a user, requesting to provide a unit function list applicable to the selected service scenario to a server through the communication part when there is a request to modify a unit function for the selected service scenario from the user, applying at least one unit function, selected by the user from the unit function list received from the server through the communication part, to the selected service scenario, and storing the result to the storing part.

A home automation supporting method from a server according to an embodiment of the present invention comprises receiving information for a service scenario from a home device; searching for at least one unit function applicable to the service scenario and transmitting a unit function list which is the result from the searching to the home device; receiving information for the at least one unit function selected from the unit function list from the home device; and applying the selected at least one unit function to the service scenario and storing the result.

A home automation supporting apparatus from a server according to an embodiment of the present invention comprises a communication part; a storing part storing a customized service; and a controlling part receiving information for a service scenario from a home device through the communication part, searching for at least one unit function applicable to the service scenario and transmitting a unit function list which is the result from the searching to the home device through the communication part, receiving information for the at least one unit function selected from the unit function list from the home device through the communication part, and applying the selected at least one unit function to the service scenario and storing the result.

According to embodiments of the present invention, customized services which fit to a user can be provided.

### BRIEF DESCRIPTION OF THE DRAWINGS

FIG. 1 illustrates a home automation system according to embodiments of the present invention.

FIG. 2A illustrates data structure of a service scenario according to an embodiment of the present invention.

FIG. 2B illustrates data structure of unit function according to an embodiment of the present invention.

FIG. 2C illustrates data structure of a unit function-service category mapping table according to an embodiment of the present invention.

FIG. 3A is a flowchart illustrating a home automation method according to an embodiment of the present invention.

FIG. 3B is a flowchart illustrating a home automation method according to another embodiment of the present invention.

FIG. 4 is a flowchart illustrating a home automation method according to still another embodiment of the present invention.

FIG. 5 is a flowchart illustrating a home automation method according to still another embodiment of the present invention.

FIG. 6 is a block view illustrating a home automation apparatus according to embodiments of the present invention.

FIG. 7 is a block view illustrating a home automation supporting apparatus according to embodiments of the present invention.

### DESCRIPTION OF THE EXEMPLARY EMBODIMENTS

Throughout the description of the present invention, when describing a certain technology is determined to evade the point of the present invention, the pertinent detailed description will be omitted.

As described above, conventional home situation-responding services cause reduction in user satisfaction since user preferences and characteristics of a house are not considered.

Exemplary embodiments of the present invention are to provide home situation-responding services appropriate to a user by considering characteristics of a user and a house.

Exemplary embodiments of the present invention are to generate user-oriented service scenarios by modifying predetermined service scenarios to fit to the user. The generated user-oriented service scenarios can be provided to another user by storing in a server.

Such user-oriented service scenarios can be re-modified by other users and the re-modified user-oriented service scenarios can be provided to other users by storing in the server.

Exemplary embodiments of the present invention will be described in detail below with reference to the accompanying drawings.

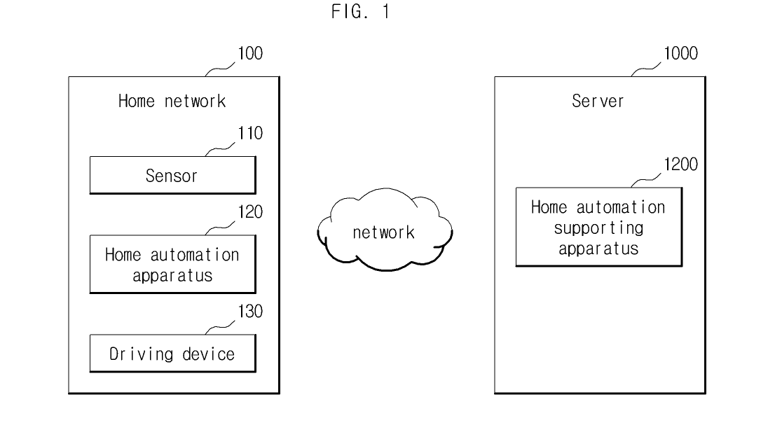

FIG. 1 illustrates a home automation system according to embodiments of the present invention. Referring to FIG. 1, the home automation system according to embodiments of the present invention comprises a home network 100 and a server 1000.

The home network 100 comprises at least one sensor 110, a home automation apparatus 120 and at least one driving device 130.

The sensor 110 may collect and transmit sensing information to a home automation apparatus 120. The sensor 110 may be installed in or out of a house, or on the driving device 130 or apart from the driving device 130. Sensing information may be collected periodically.

The home automation apparatus 120 determines home situation using sensing information received from the sensor 110 and selects a basic service scenario corresponding to the determined home situation to provide a home situation-responding service. The home automation apparatus 120 may store at least one basic service scenario.

The home automation apparatus 120 generates user-oriented service scenarios for user-oriented home situation-responding services to provide home situation-responding services using them. The home automation apparatus 120 may receive at least one of an available service scenario list, a unit function list and a unit function description from the home automation supporting apparatus 1200. The home automation apparatus 120 may also apply the unit function description modified by the user to the service scenario selected by the user to generate a user-oriented service scenario. During the generation of the user-oriented service scenario, a part of the existing unit functions may be eliminated according to a user's selection.

The home automation apparatus 120 may receive a user-oriented service scenario generated by another user and provide a home situation-responding service using it.

Service scenario may include unit functions to control the driving device 130. The unit function may be used to control one driving device 130 and be represented as description. Service scenario (it is used to include basic service scenarios and user-oriented service scenarios) may include a plurality of unit functions to control a plurality of driving devices 130.

The home automation apparatus 120 may store a driving program module corresponding to each unit function. The home automation apparatus 120 may read a unit function description included in the corresponding service scenario and control the driving device 130 using a driving program module which corresponds to the driving device 130 specified in the read unit function description when a home situation-responding service is provided according to a selected service scenario.

The home automation apparatus 120 may receive a driving program module corresponding to a unit function included in the corresponding service scenario from the automation supporting apparatus 1200 and store it when the user-oriented service scenario is generated or received. In an embodiment, the home automation apparatus 120 may also determine if itself stores the driving program module corresponding to a unit function included in the corresponding service scenario and request to send only driving program modules, which it does not store, to the home automation supporting apparatus 1200.

The driving device 130 operates under the control of the home automation apparatus 120. The driving device 130 may be located in or out of a house. The driving device 130 may be electronics such as an air conditioner, a TV, a refrigerator, a stove, a humidifier, a washing machine, a microwave oven, a window, a gate and the like or any device attached to such electronics.

The server 1000 includes the home automation supporting apparatus 1200.

The home automation supporting apparatus 1200 may communicate with the home automation apparatus 120 using a predetermined communication method.

The home automation supporting apparatus 1200 may store basic service scenarios. The basic service scenarios may be transmitted to the home automation apparatus 120 when there is a request from the home automation apparatus 120.

The home automation supporting apparatus 1200 may transmit at least one of an available service scenario list, a unit function list and unit function description to the home automation apparatus 120 with the request from the home automation apparatus 120.

The home automation supporting apparatus 1200 may generate and store a user-oriented service scenario. The home automation supporting apparatus 1200 may receive at least one of service scenario information, unit function information and modified unit function description which can be used to generate a user-oriented service scenario from the home automation apparatus 120. The home automation supporting apparatus 1200 may also generate a user-oriented service scenario by applying the modified unit function description to the corresponding service scenario. The generated user-oriented service scenario may be stored, be provided to another user when there is a request from the another user, and be modified by the another user.

The home automation supporting apparatus 1200 may transmit a driving program module, which is used to provide a home situation-responding service using the user-oriented service scenario, to the home automation apparatus 120. The transmission may be performed when there is a request from the home automation apparatus 120 or according to the determination by the home automation supporting apparatus 1200.

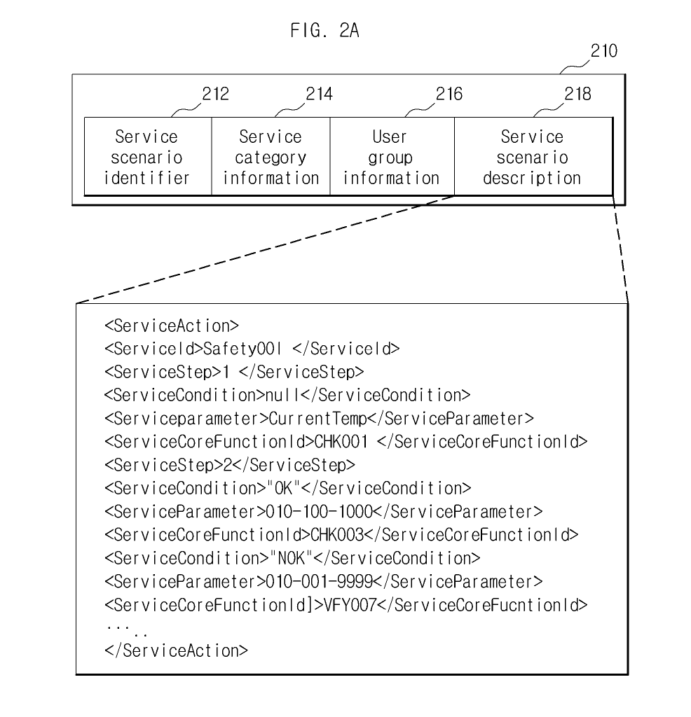

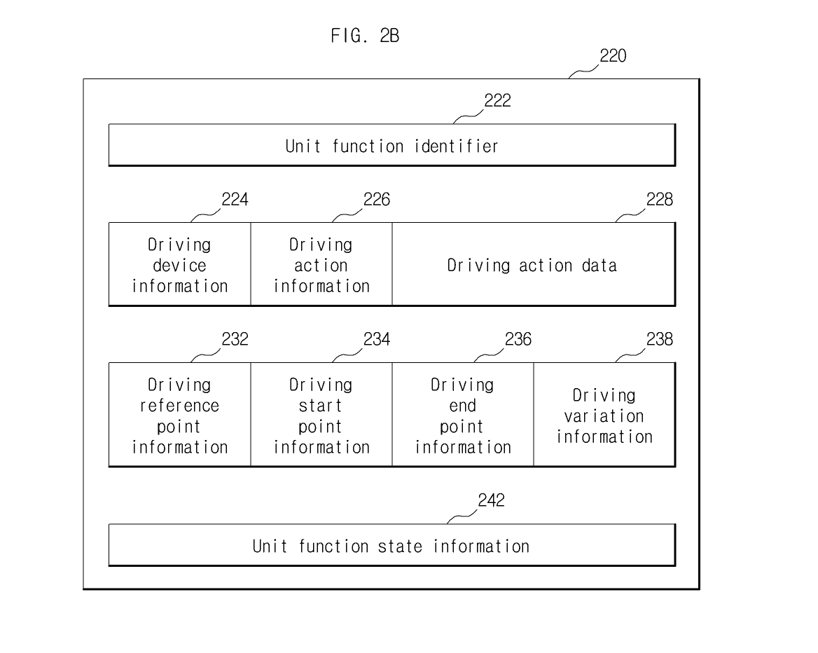

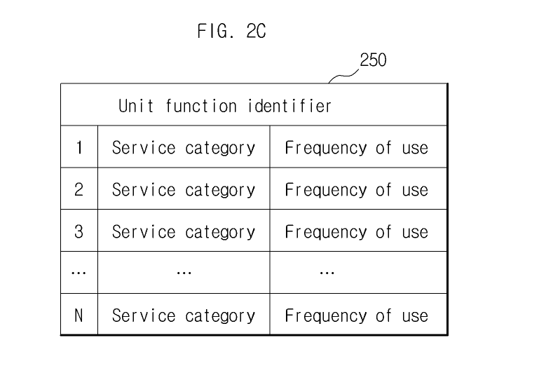

Data structure will be described with reference to FIG. 2A, FIG. 2B and FIG. 2C below.

FIG. 2A illustrates data structure of a service scenario according to an embodiment of the present invention.

Referring to FIG. 2A, a service scenario may include at least one of service scenario identifier 212 which is used to identify a corresponding service scenario, service category information 214 to which a corresponding service scenario belongs, user group information 216 which represents a user group mainly using a corresponding service scenario, and service scenario description 218 which is used to execute a corresponding service scenario.

The user group information 216 may be updated by the home automation supporting apparatus 1200. For example, a service manager may appoint a user group for each home automation apparatus 120. When a service scenario is used by the home automation apparatus 120, the home automation supporting apparatus 1200 may update the user group information 216 by applying the user group of a corresponding home automation apparatus 120. The user group information 216 may be referenced when it is used for the service scenario and its service process or contents may be applied differently according to user groups.

The service scenario description 218 may be read by the home automation apparatus 120 during providing a home situation-responding service. The service scenario description 218 may include at least one unit function description.

FIG. 2B illustrates data structure of unit functions according to an embodiment of the present invention.

Unit function description 220 may include at least one of a unit function identifier 222, driving device information 224, driving action information 226, driving action data 228, driving reference point information 232, driving start point information 234, driving end point information 236, driving variation information 238 and unit function state information 242.

The unit function identifier 222 may be used to identify a corresponding unit function description

The driving device information 224 may represent a driving device to be controlled according to the corresponding unit function description.

The driving action information 226 may define action of the driving device to be controlled according to the corresponding unit function description. For example, when a driving device to be controlled is an air conditioner, it may define power on/off action.

The driving action data 228 may include data to refer during control or the driving device. For example, when a driving device to be controlled is an image phone, it may include video or audio data to be displayed when a phone call is made.

The driving reference point information 232 may define information to be reference to determine if a driving device has to be controlled or not. For example, the driving reference point information 232 may be critical point information. For example, when a driving device to be controlled is an air conditioner, it may regulate information to drive the air conditioner when the outside temperature reaches to a certain temperature.

The driving start point information 234 may indicate a start setting value of a driving device. For example, when a driving device is a refrigerator which has 5 labeled setting values to control the temperature, it may regulate which label the refrigerator has to drive from.

The driving end point information 236 may indicate an end setting value of a driving device. For example, when a driving device is a refrigerator which has 5 labeled setting values to control the temperature, it may regulate which label the refrigerator has to stop driving from.

The driving variation information 238 may include drive amplitude information. For example, when the label of a refrigerator is changed from 3 to 4, it may include information about how long it takes to change to label 4. For example, it may include information about how much window has to be opened per a gas sensing value.

The unit function state information 242 provides current state of a unit function. For example, the unit function state information 242 may represent if a corresponding unit function could be performed or not. For example, a unit function to drive an air conditioner may be indicated as ‘possible’ or ‘impossible’ and this state information can be provided to a service manager.

FIG. 2C illustrates data structure of a unit function-service category mapping table according to an embodiment of the present invention.

A unit function-service category mapping table 250 stores a frequency of use per service category of for each unit function.

The unit function-service category mapping table 250 may be updated when a new user-oriented service scenario is generated. For example, when a service scenario included in a ‘ventilation’ category is selected and a new user-oriented service scenario is generated by applying ‘open and shut a window’ unit function to the selected service scenario, frequency of use of the ‘ventilation’ category may be reflected to a unit function-service category mapping table corresponding to the ‘open and shut a window’ unit function. The reflection may be different depending on the presence/absence of the corresponding category in the corresponding unit function-service category mapping table. For example, when the ‘ventilation’ category is present in the unit function-service category mapping table corresponding to the ‘open and shut a window’ unit function, frequency of use of the ‘ventilation’ category can be increased by 1. For example, when the ‘ventilation’ category is not present in the unit function-service category mapping table corresponding to the ‘open and shut a window’ unit function, the ‘ventilation’ category item can be added in the corresponding mapping table or be overwritten on the item with the lowest frequency of use among existing items.

A home automation method according to embodiments of the present invention will be described with reference to the related drawings hereinafter.

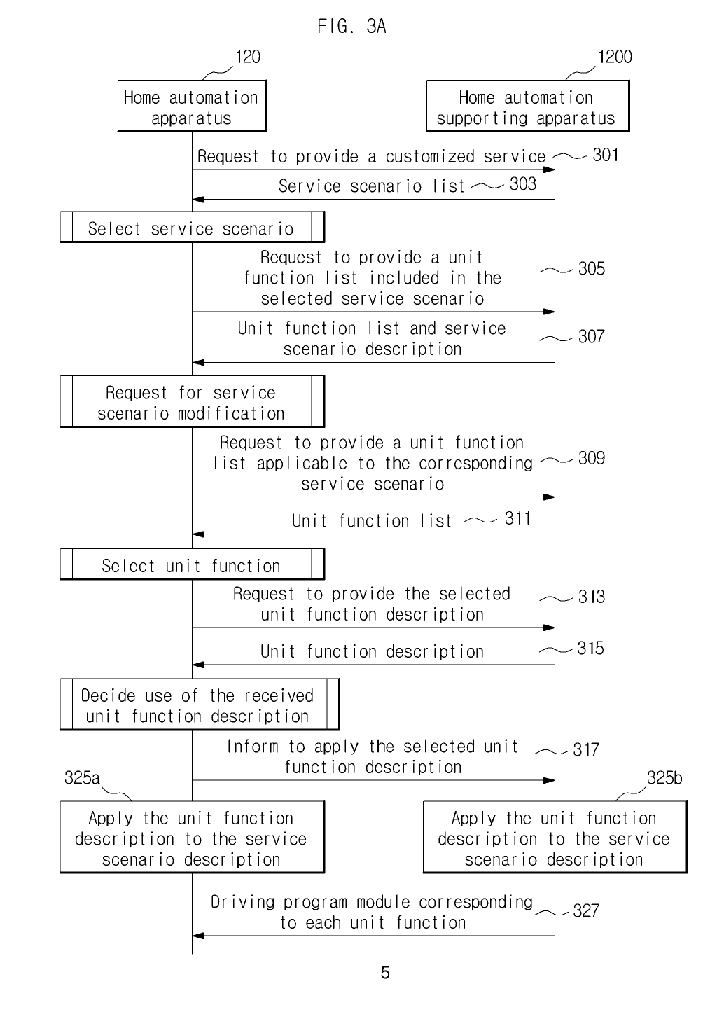

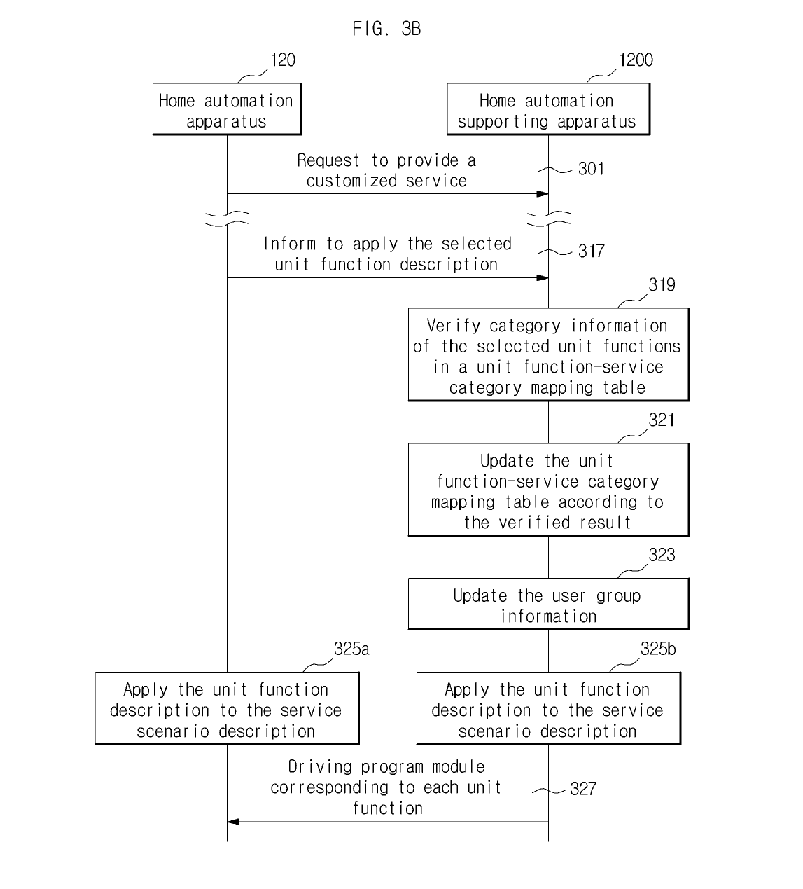

FIG. 3A is a flowchart illustrating a home automation method according to an embodiment of the present invention. A part of the steps shown in FIG. 3A may be omitted.

In Step 301, a home automation apparatus 120 requests to provide a customized service to a home automation supporting apparatus 1200. The request may be performed with a user's request.

In Step 303, the home automation supporting apparatus 1200 searches for service scenarios available for the home automation apparatus 120 and transmits the available service scenario list to the home automation apparatus 120. Service scenarios in the available service scenario list may be basic service scenarios or user-oriented service scenarios generated by other users. The available service scenario list may include at least one of service category information to which each service scenario belongs and service scenario names (identifiers).

In Step 305, the home automation apparatus 120, when a scenario from the received available service scenario list is selected by a user, may request to provide a unit function list included in the corresponding service scenario to the home automation supporting apparatus 1200. For such a request, the home automation apparatus 120 may generate a request message including an identifier of the selected service scenario and send it to the home automation supporting apparatus 1200.

In Step 307, the home automation supporting apparatus 1200 then transmits the list of the unit functions included in the corresponding service scenario to the home automation apparatus 120. The home automation supporting apparatus 1200 may also transmit corresponding service scenario description to the home automation apparatus 120.

In Step 309, the home automation apparatus 120, when there is a request to modify a service scenario from the user, may request to provide a unit function list applicable to the corresponding service scenario to the home automation supporting apparatus 1200.

In Step 311, the home automation supporting apparatus 1200 searches for unit functions applicable to the corresponding service scenario to generate a unit function list and transmits the result to the home automation apparatus 120. In an embodiment, the home automation supporting apparatus 1200 may generated a unit function list from the unit functions ranked within a priority of service categories to which the service scenario belongs by referring unit function-service category mapping table.

In Step 313, the home automation apparatus 120, when a unit function is selected by the user, request to provide description of the selected unit function to home automation supporting apparatus 1200.

In Step 315, the home automation supporting apparatus 1200 searches for and transmits the requested unit function description to the home automation apparatus 120. When the user selects a plurality of unit function in order, the process from Step 313 to Step 315 may be repeated.

When the user input of the decision to use the unit function description received from the home automation supporting apparatus 1200, in Step 317, the home automation apparatus 120 informs to apply the unit function description to the service scenario to the home automation supporting apparatus 1200.

In Step 325a and Step 325b, the home automation apparatus 120 and the home automation supporting apparatus 1200 apply the unit function selected by the user to the service scenario which may be that the unit function description is reflected to the service scenario description.

In Step 327, the home automation supporting apparatus 1200 transmits driving program modules corresponding to each selected unit function to the home automation apparatus 120.

The home automation apparatus 120 may then provide home situation-responding services using the received driving program modules.

FIG. 3B is a flowchart illustrating a home automation method according to another embodiment of the present invention.

Since Step 301 to Step 317 in FIG. 3B are the same as Step 301 to Step 317 in FIG. 3A, detailed explanation is omitted.

In Step 319, the home automation supporting apparatus 1200 verifies category information of the selected unit functions in a unit function-service category mapping table. That is, it determines which service category each unit function is belongs to.

In Step 321, the home automation supporting apparatus 1200 updates the unit function-service category mapping table according to the verified result. Since update of the unit function-service category mapping table is the same as that described in FIG. 2C, the detailed explanation is omitted.

In Step 323, the home automation supporting apparatus 1200 updates the user group information.

Since Step 325a, Step 325b and Step 327 in FIG. 3B are the same as those described in Step 325a, Step 325b and Step 327 with FIG. 3A, the detailed explanation is omitted.

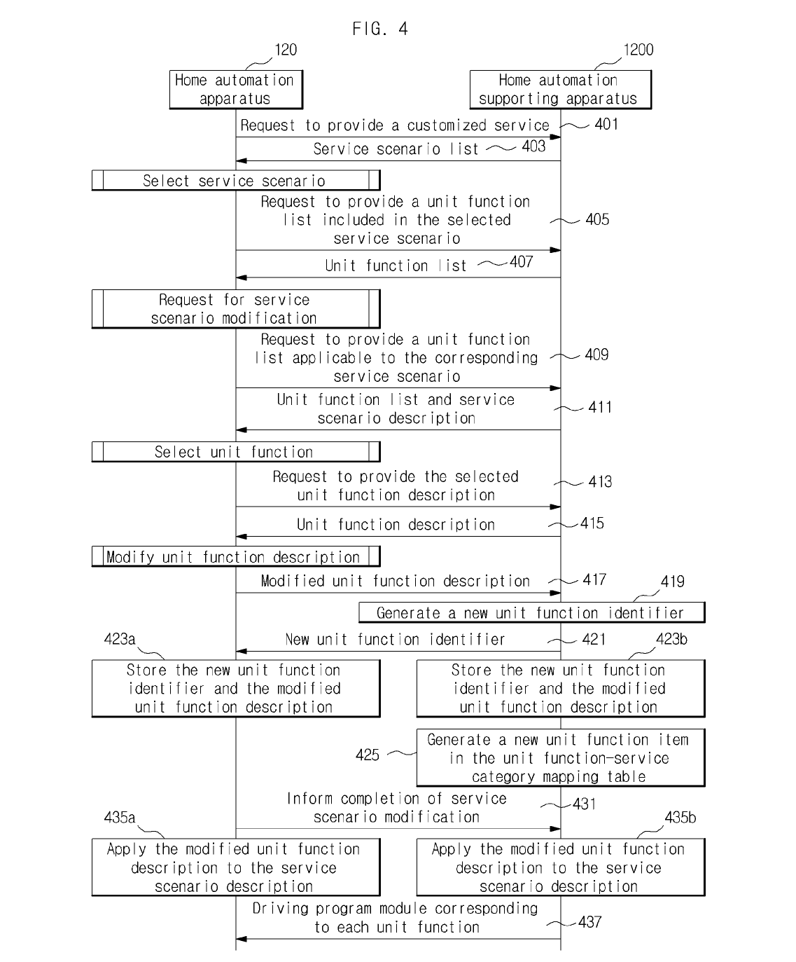

FIG. 4 is a flowchart illustrating a home automation method according to still another embodiment of the present invention. A part of steps shown in FIG.4 may be omitted.

Since Step 401 to Step 415 in FIG. 4 are the same as those described in Step 301 to Step 315 with FIG. 3A, the detailed explanation is omitted.

When there is modification for the received unit function description, in Step 417, the home automation apparatus 120 transmits the modified unit function description to the home automation supporting apparatus 1200.

In Step 419, the home automation supporting apparatus 1200 generates a new unit function identifier for the modified unit function description and then proceeds to Step 421 to transmit the new unit function identifier to the home automation apparatus 120.

In Step 423a and Step 423b, the home automation apparatus 120 and the home automation supporting apparatus 1200 store the new unit function identifier and the modified unit function description. It means generation of a new unit function by combining or mapping the new unit function identifier and the modified unit function description.

In Step 425, the home automation supporting apparatus 1200 generates an item corresponding to the new unit function identifier in the unit function-service category mapping table.

In Step 431, the home automation apparatus 120 informs completion of service scenario modification to the home automation supporting apparatus 1200. This may be a case that the user selects that no other unit function description will be modified.

The user may verifies or modifies description for one or more unit functions. Therefore, at least one step among Step 405 to Step 425 may be repeated till completion of service scenario modification is informed.

In Step 435a and Step 435b, the home automation apparatus 120 and the home automation supporting apparatus 1200 apply the description of the modified unit functions to currently selected service scenario description. This may mean the generation of the new service scenario in which the modified unit function is included.

In embodiments described with reference to FIG. 4, even though examples of generating new service scenarios in the home automation apparatus 120 and the home automation supporting apparatus 1200 are explained, the new service scenario can be generated in one apparatus and then be transmitted to the other apparatus. In this case, at least one of Step 423a, Step 423b, Step 431, Step 435a, and Step 435b may be omitted.

Even though it is not illustrated, processes for updating the unit function-service mapping table and the user group information may be added between Step 425 and Step 435b. Since they are the same as those described in Step 319 to Step 323 with FIG. 3B, the detailed explanation is omitted.

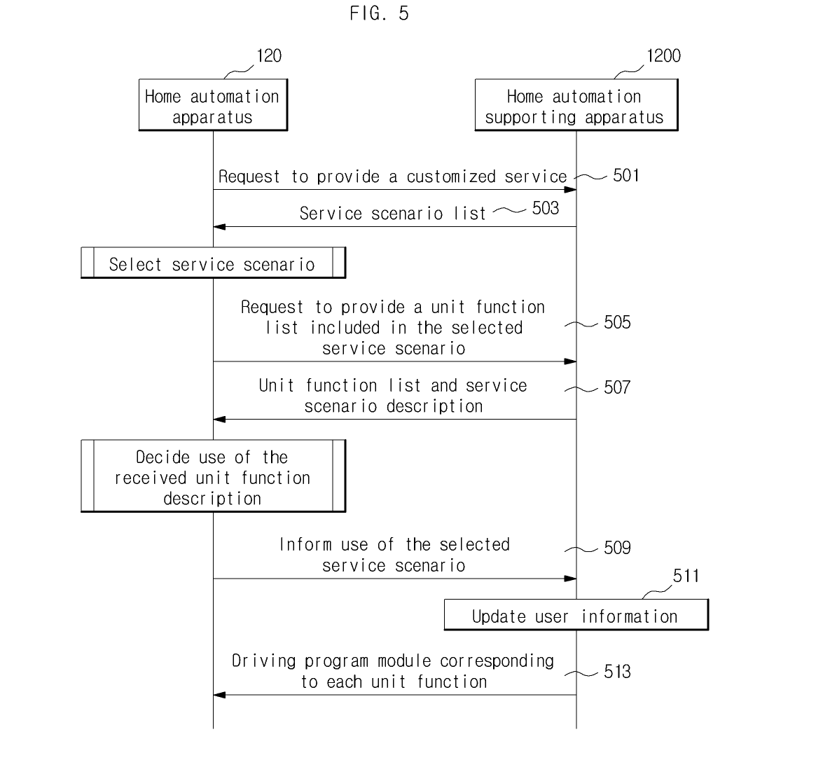

FIG. 5 is a flowchart illustrating a home automation method according to still another embodiment of the present invention. A part of the steps shown in FIG. 5 may be omitted.

Since Step 501 to Step 507 in FIG. 5 are the same as those described in Step 301 to Step 307 with FIG. 3, the detailed explanation is omitted.

When the user decides to use unit functions included in the service scenario without any addition or deletion, in Step 509, the home automation apparatus 120 informs that the selected service scenario will be used as it is to the home automation supporting apparatus 1200.

In Step 511, the home automation supporting apparatus 1200 updates the user group information and proceeds to Step 513 to transmit driving program modules corresponding to the unit functions included in the corresponding service scenario to the home automation apparatus 120.

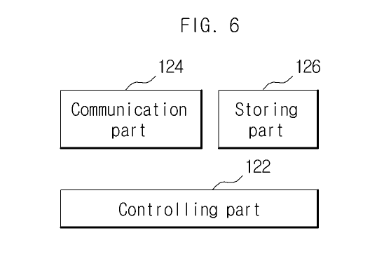

FIG. 6 is a block view illustrating a home automation apparatus according to embodiments of the present invention.

Referring to FIG. 6, the home automation apparatus 120 according to an embodiment of the present invention includes a controlling part 122, a communication part 124 and a storing part 126. At least one of these components may be omitted.

The controlling part 122 may control operations to generate user-oriented service scenarios and communicate with the home automation supporting apparatus 1200 through the communication part 124. The controlling part 122 may request to the home automation supporting apparatus 1200 to send a service scenario list, service scenario description, a unit function list and unit function description in order to generate user-oriented service scenarios. The controlling part 122 may also generate user-oriented service scenarios by applying the unit functions, selected by the user among the unit functions included in the unit function list received from the home automation supporting apparatus 1200, to the service scenario selected by the user, and store the result to the storing part 126. The unit function description may be modified by the user and in this case, the controlling part 122 may receive a new identifier from the home automation supporting apparatus 1200, combine with the modified description, and apply the result to the service scenario selected by the user to generate a user-oriented service scenario.

The controlling part 122 may receive driving program modules corresponding to the unit functions included in the user-oriented service scenario from the home automation supporting apparatus 1200 and store the received driving program modules in the storing part 126.

The storing part 126 may store service scenarios, driving program modules and the like. The storing part 126 may store sensing value information to determine home situation. For example, it may store information indicating which sensing value represents which home situation. It may also store by mapping service scenario items to be applied according to home situation. Such information may be used when the controlling part 122 provides home situation responding services.

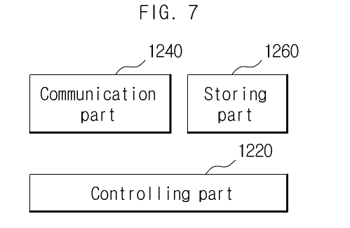

FIG. 7 is a block view illustrating a home automation supporting apparatus according to embodiments of the present invention.

Referring to FIG. 7, the home automation supporting apparatus according to still another embodiment of the present invention 1200 includes a controlling part 1220, a communication part 1240 and a storing part 1260. At least one of these components may be omitted.

The controlling part 1220 may control operations to generate user-oriented service scenarios and communicate with the home automation apparatus 120 through the communication part 1240.

The controlling part 1220, when there is a request to generate a user-oriented service scenario from the home automation apparatus 120, may performs corresponding operations to search for necessary information and transmit the result to the home automation apparatus 120.

The controlling part 1220 may search for unit functions applicable in the service scenario selected by the user and transmit the searched unit functions to the home automation apparatus 120. The controlling part 1220 may generate a user-oriented service scenario by applying unit function selected by the user to the selected service scenario and store the generated user-oriented service scenario in the storing part 1260. During the searching for the applicable unit functions, the controlling part 1220 may search for unit functions ranked within a priority of service categories to which the service scenario belongs by referring to a the unit function-service category mapping table.

When the modified unit function description is received from the home automation apparatus 120, the controlling part 1220 may generate a new identifier for the corresponding unit function description and combine the new identifier and the modified unit function description to apply the result to the service scenario selected by the user and generate a user-oriented service scenario. The generated new identifier may be transmitted to the home automation apparatus 120.

The controlling part 1220 may transmit driving program modules corresponding to the unit functions included in the user-oriented service scenario to the home automation apparatus 120. When the new user-oriented service scenario is generated, the controlling part 1220 may update the unit function-service category mapping table based on the unit functions used to generate the user-oriented service scenario and the service category to which the corresponding user-oriented service scenario belongs.

The storing part 1260 may store basic service scenarios and user-oriented service scenarios. The storing part 1260 may store unit function modified by the user for generation of the user-oriented service scenarios. The storing part 1260 may also store the unit function-service category mapping table.

The exemplary embodiment of the present invention can be implemented by various method. For example, the exemplary embodiment of the present invention can be implemented by using hardware, software or its combination. When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A user-based home automation method in a home device, the method comprising:
selecting a service scenario comprising at least one unit function, the service scenario being selected by a user;
requesting to provide a unit function list applicable to the selected service scenario to a server when there is a request to modify a unit function for the selected service scenario from the user; and
applying at least one unit function, selected by the user from the unit function list received from the server, to the selected service scenario and storing the result.

2. The user-based home automation method of claim 1, further comprising receiving a driving program module corresponding to the selected unit function from the server.

3. The user-based home automation method of claim 1, further comprising:
determining home situation on the basis of sensing information; and
performing service scenario corresponding to the determined home situation from the stored service scenarios.

4. The user-based home automation method of claim 1, further comprising:
receiving a description for the selected unit function from the server;
when the user modifies the description, receiving a new identifier for the modified description from the server; and
combining the new identifier and the modified description, applying the result of combining to the selected service scenario.

5. A user-based home automation apparatus in a home device, the apparatus comprising:
a communication part
a storing part; and
a controlling part receiving a selection of a service scenario comprising at least one unit function from a user, requesting to provide a unit function list applicable to the selected service scenario to a server through the communication part when there is a request to modify a unit function for the selected service scenario from the user, applying at least one unit function selected by the user from the unit function list received from the server to the selected service scenario, and storing the result to the storing part.

6. The user-based home automation apparatus of claim 5, wherein the controlling part receives a driving program module for the selected unit function from the server.

7. The user-based home automation apparatus of claim 5, wherein the controlling part determines home situation on the basis of sensing information received from at least one sensor; and performs service scenario corresponding to the determined home situation from the stored service scenarios.

8. The user-based home automation apparatus of claim 5, wherein the controlling part receives a description for the selected unit function from the server, receives a new identifier when the user modifies the description from the server, combines the new identifier and the modified description, applies the result of combining to the selected service scenario.

9. A user-based home automation supporting method in a server, the method comprising:
receiving information for a service scenario from a home device;
searching for at least one unit function applicable to the service scenario and transmitting a unit function list which is the result from the searching to the home device;
receiving information for the at least one unit function selected from the unit function list from the home device; and
applying the selected at least one unit function to the service scenario and storing the result.

10. The user-based home automation supporting method of claim 9, further comprising transmitting a driving program module corresponding to the selected unit function to the home device.

11. The user-based home automation supporting method of claim 9, further comprising:
transmitting a description for the selected unit function to the home device;
receiving modified description from the home device;
generating a new identifier for the modified description; and
combining the new identifier and the modified description, applying the result to the service scenario.

12. The user-based home automation supporting method of claim 11, further comprising transmitting the new identifier to the home device.

13. The user-based home automation supporting method of claim 9, wherein the step of searching for at least one unit function applicable to the service scenario comprises searching for unit functions ranked within a priority of service categories to which the service scenario belongs by referring to a table storing a frequency of use per service category for each unit function.

14. The user-based home automation supporting method of claim 13, further comprising updating the table on the basis of the selected unit function and the service category to which the service scenario belongs.

15. A user-based home automation supporting apparatus, the apparatus comprising;
a communication part;
a storing part storing a customized service; and
a controlling part receiving information for a service scenario from a home device through the communication part, searching for at least one unit function applicable to the service scenario and transmitting a unit function list which is the result from the searching to the home device through the communication part, receiving information for the at least one unit function selected from the unit function list from the home device through the communication part, and applying the selected at least one unit function to the service scenario and storing the result.

16. The user-based home automation supporting apparatus of claim 15, wherein the controlling part transmits a driving program module corresponding the selected unit function to the home device.

17. The user-based home automation supporting apparatus of claim 15, wherein the controlling part transmits a description for the selected unit function to the home device, generates a new identifier when modified description is received from the home device to combine with the modified description, applies the result of combining to the service scenario.

18. The user-based home automation supporting apparatus of claim 17, wherein the controlling part transmits the new identifier to the home device.

19. The user-based home automation supporting apparatus of claim 18, wherein the controlling part searches for unit functions ranked within a priority of service categories to which the service scenario belongs by referring to a table storing a frequency of use per service category for each unit function.

20. The user-based home automation supporting apparatus of claim 19, wherein the controlling part updates the table on the basis of the selected unit function and the service category to which the service scenario belongs.
